(19) United States
(12) Patent Application Publication
(10) Pub. No.: US 2022/0284008 A1
(43) Pub. Date: Sep. 8, 2022

(54) METHOD AND SYSTEM OF IMPLEMENTING PARTITIONED BLOCKCHAIN

(71) Applicant: MASTERCARD INTERNATIONAL INCORPORATED, Purchase, NY (US)

(72) Inventor: Thomas TREITLINGER, Dublin (IE)

(73) Assignee: MASTERCARD INTERNATIONAL INCORPORATED, Purchase, NY (US)

(21) Appl. No.: 17/189,521

(22) Filed: Mar. 2, 2021

(51) Int. Cl. G06F 16/23; G06F 16/27

(52) U.S. Cl. CPC G06F 16/2379; G06F 16/278

(57) ABSTRACT

A method for representing state of an asset through a partitioned blockchain includes: storing a partitioned blockchain including a plurality of blocks; receiving a first new block including at least one first new transaction data value for each of a plurality of partition groups, where one of the first new transaction data values in a first partition group includes a specific asset identifier; receiving a second new block including at least one second new transaction data value for each of the plurality of partition groups, where one of the second new transaction data values in a second partition group includes the specific asset identifier; detecting the specific asset identifier in the second partition group in the second new block; and performing one or more predetermined actions after detecting the specific asset identifier.

### FIELD

The present disclosure relates to the implementation of a partitioned blockchain, specifically the use of asset identifiers stored in different partitions of a partitioned blockchain to represent state data for assets.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

Because blockchains store an immutable record for any manner of data, some blockchains have been developed to store information regarding the provenance of items, such as tracking the production and distribution of perishable goods or high value items. For example, a blockchain may be used to track produce, where an entry may be created when the produce is harvested, picked up from the harvesting location, dropped off at a distributor, loaded into a truck by the distributor, arrived at a retailer, accepted by the retailer, and sold to a consumer. By storing entries related to these actions on the blockchain, a consumer or other interested party can quickly see an immutable record of the life of the produce, such as to ensure its age and freshness, or to check to see if the produce is sourced from a sustainable farm. Additionally, if produce needs to be recalled, an immutable record of all produce may make it easier to track where recallable items are located.

However, storing such information regarding provenance of assets requires each entry to include information regarding the asset, information on the state of the asset, information on any related entity, and any other information necessary for the tracking and status of the asset. As the number of products being tracked on a blockchain increase, and as the number of different status updates for a product increases, the amount of entries stored in the blockchain can grow exceedingly fast. As a result, the data size of the blockchain can become increasingly large very quickly, which may become difficult for interested parties to navigate and require a large amount of bandwidth.

Thus, there is a need for a better method of storing state information of assets on a blockchain with reduced data sizes and easier navigation.

### SUMMARY

The present disclosure provides a description of systems and methods for representing state of an asset through a partitioned blockchain. A partitioned blockchain can be split into as many partitions as necessary, where each partition may be associated with a state for assets. The association between partitions and asset states may be known publicly, may be known by the nodes, or may only be known by authorized parties where any other entity may be unaware of the significance of the partitions. When the state of an asset is to be updated, a new entry is made in the blockchain where an identifier for that asset is stored in a new entry that is included in the partition that is associated with the new state. Nodes in the blockchain network for the blockchain can identify when the identifier for an asset is stored in a new partition than previously, which may result in the automatic execution of new actions or processes. As a result, the partitioned blockchain may be used to both represent the state of an asset, while also ensuring updates to asset state are treated as events that can result in automated processes being initiated. The use of a partitioned blockchain to store the data, and treating the partitions as different states, can enable state information for assets to be stored using as little as the identifier for the asset itself. This can provide for a significantly smaller file size than with a traditional blockchain, as well as streamlining the process for identifying the state of an asset over traditional methods.

A method for representing state of an asset through a partitioned blockchain includes: storing, in a memory of a blockchain node in a blockchain network, a partitioned blockchain, the partitioned blockchain including a plurality of blocks; receiving, by a receiver of the blockchain node, a first new block including at least a first block header and at least one first new transaction data value for each of a plurality of partition groups, where one of the one or more first new transaction data values included in a first partition group of the plurality of partition groups includes a specific asset identifier; receiving, by the receiver of the blockchain node, a second new block including at least a second block header and at least one second new transaction data value for each of the plurality of partition groups, where one of the one or more second new transaction data values included in a second partition group of the plurality of partition groups includes the specific asset identifier; detecting, by a processor of the blockchain node, the specific asset identifier included in the one of the one or more transaction data values included in the second partition group in the second new block; and performing, by the processor of the blockchain node, one or more predetermined actions after detecting the specific asset identifier.

A system for representing state of an asset through a partitioned blockchain includes: a blockchain network; and a blockchain node included in the blockchain network, the blockchain node including a memory storing a partitioned blockchain, the partitioned blockchain including a plurality of blocks, a receiver receiving a first new block including at least a first block header and at least one first new transaction data value for each of a plurality of partition groups, where one of the one or more first new transaction data values included in a first partition group of the plurality of partition groups includes a specific asset identifier, and a second new block including at least a second block header and at least one second new transaction data value for each of the plurality of partition groups, where one of the one or more second new transaction data values included in a second partition group of the plurality of partition groups includes the specific asset identifier, and a processor detecting the specific asset identifier included in the one of the one or more transaction data values included in the second partition group in the second new block, and performing one or more predetermined actions after detecting the specific asset identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for representing state of an asset through a partitioned blockchain in accordance with exemplary embodiments.

FIG. 2 is a block diagram illustrating a blockchain node of the system of FIG. 1 for representing state of assets through partitioned blockchains in accordance with exemplary embodiments.

FIG. 3 is a flow diagram illustrating a process for representing state of an asset through a partitioned blockchain in accordance with exemplary embodiments.

FIG. 4 is a flow chart illustrating an exemplary method for representing state of an asset through a partitioned blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Representing Asset States Through Partitioned Blockchains

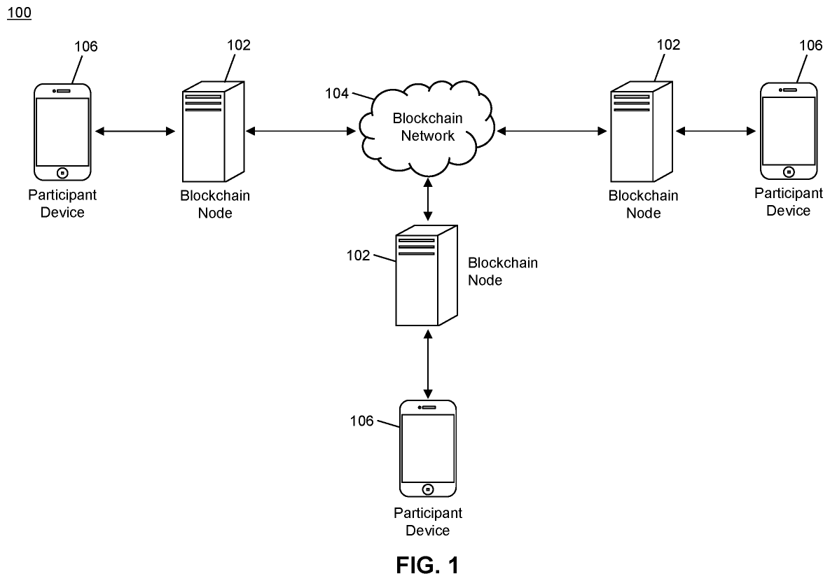

FIG. 1 illustrates a system 100 for representing the state of an asset through the use of partitions in a partitioned blockchain.

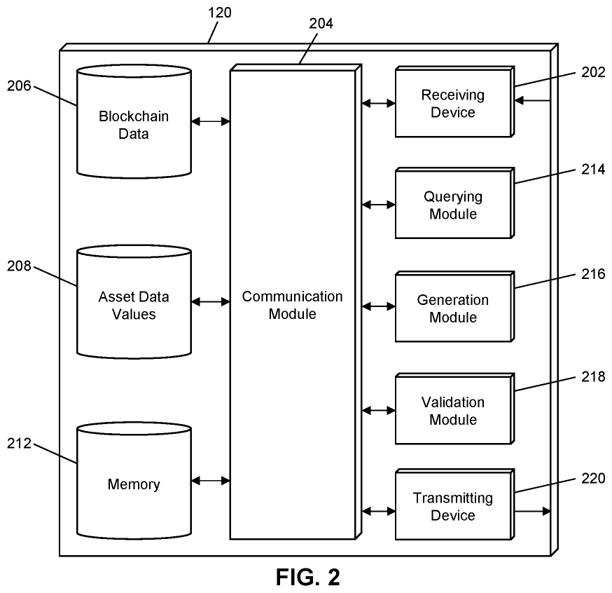

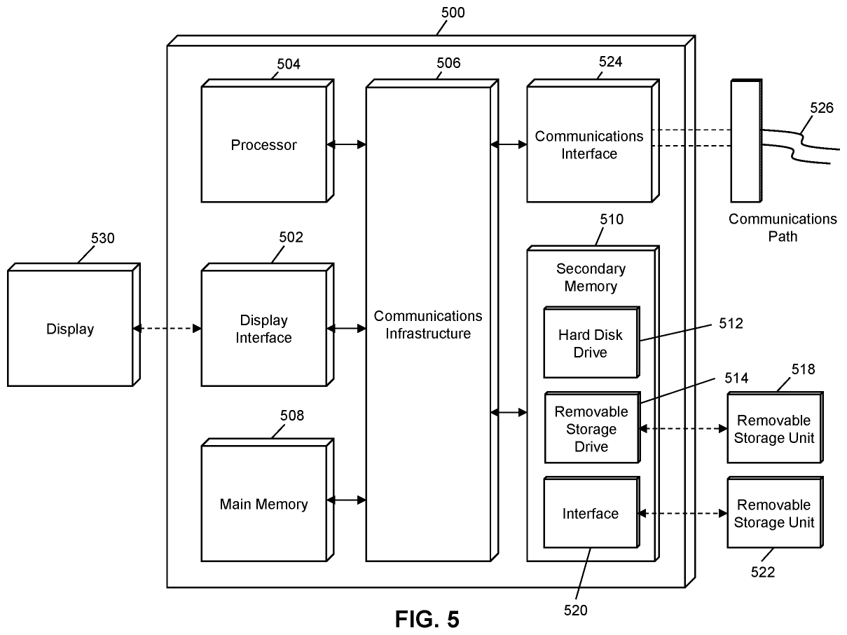

The system 100 may include one or more blockchain nodes 102. Each blockchain node 102 may be part of a blockchain network 104. Each blockchain node 102 may be a computing system, such as illustrated in FIGS. 2 and 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device (e.g., participant devices 106) that stores the private key for use thereof in blockchain transactions. For instance, each computing device may each have their own private key for respective cryptographic key pairs, and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of currency (e.g., a participant device 106) that is generated using the sender's private key, a blockchain address of the recipient of currency (e.g., another participant device 106) generated using the recipient's public key, and a blockchain currency amount that is transferred or other data being stored. In the case of the blockchain being used for data storage separate from currency, the currency amount may be replaced by such other data. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 102 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 104 before being added to the blockchain and distributed to all of the blockchain nodes 102 in the blockchain network 104 in traditional blockchain implementations. In cases where a blockchain data value may not be related to a blockchain transaction, but instead the storage of other types of data, blockchain data values may still include or otherwise involve the validation of a digital signature.

The system 100 may use a partitioned blockchain. A partitioned blockchain may be a blockchain where the blockchain data values stored therein may be separated into partitions, which may be represented through subnets where each partition has its own identifier associated therewith. In some cases, the header for a block in a partitioned blockchain may include data pairs that may be comprised of the subnet identifier for the partition and the root of a Merkle tree for all blockchain data values included in the block for that partition, similar to the data reference value in the block header of a standard blockchain. Additional information regarding partitioned blockchains may be found in U.S. Pat. No. 10,097,344, entitled “Method and System for Partitioned Blockchains and Enhanced Privacy for Permissioned Blockchains,” by Steven Charles Davis, issued on Oct. 9, 2018, which is herein incorporated by reference in its entirety. Other configurations for partitioned blockchains may be suitable for use in the methods and systems discussed herein.

In the methods and systems discussed herein, the blockchain may be used to store information regarding assets. The assets may be digital assets or may be physical assets where associated data is stored in the blockchain. For instance, each asset may be stored in the blockchain via an asset identifier, which may be a unique value associated with the asset. In some embodiments, the asset identifiers stored in the blockchain may be hash values, encrypted values, or otherwise modified from a separate identifier that is associated with the asset itself. For example, in a blockchain that is used to track the manufacture and distribution of high value goods, such as diamonds, each diamond may have a unique identifier associated therewith, such as may be inscribed in the gem itself, but where the asset identifier stored in the blockchain may be a hashed version of the unique identifier. In such cases, only an entity in possession or with knowledge of the unique identifier may be able to determine the hashed version to identify state information fort that diamond in the blockchain.

In the system 100, the blockchain may be separated into partitions where each partition represents a state value for the assets whose information is stored in the blockchain. In some instances, the blockchain itself may store data regarding the state value represented by each partition, such as by having the partition identifier indicate the represented state value. In other instances, the partitions may be identified via generic identification values (e.g., integer numbers, hexadecimal values, etc.), where information regarding which state value is represented by the partition may be available to interested or authorized parties. For example, the blockchain may be used for tracking the manufacture and distribution of controlled pharmaceuticals, where the state values represented by partitions may only be known by authorized government agencies and entities, such as for greater security.

When the state value for an asset is to be updated, a new blockchain data value may be created for that asset, such as that may include the asset identifier for the asset, and included in a partition related to the appropriate state value. The new blockchain data value may be included in that partition in a new block that is generated and distributed to other blockchain nodes 102 in the blockchain network 104. The new block may be confirmed and added to the blockchain, where the new state value of the asset can then be viewed by anyone with access to the blockchain. The state value may be identified by virtue of the partition that includes a blockchain data value with the asset identifier without the need for any data regarding the state value itself to be stored in the blockchain data value or anywhere in the blockchain, thereby significantly reducing the file size of blockchain data values and therefore the blockchain as a whole.

In some embodiments, blockchain data values may include additional data, such as related to the entity that submitted the update to the state value of the asset. In an example, the blockchain may be used to track the manufacture and distribution of a designer handbag. The blockchain may include partitions to represent the manufacture of the handbag (partition A), pickup of the handbag by a distributor (partition B), arrival of the handbag at a distribution facility (partition C), loading of the handbag into a vehicle for distribution (partition D), delivery of the handbag at a retailer (partition E), and sale of the handbag by the retailer (partition F). Each time the state value is to be updated for the handbag, a new blockchain data value may be created and included in the appropriate partition which is included in a new block that is confirmed and added to the blockchain. The blockchain data value may also include data regarding the entity that submitted the update for the state value.

For instance, in the above example, the manufacturer may submit the asset identifier to a blockchain node 102 using a participant device 106 when the handbag is manufactured. In a further example, the handbag may have a unique identifier stitched therein or otherwise included therewith (e.g., printed on a tag attached to the handbag, stored in a radio frequency identification tag embedded inside the handbag, etc.) that is submitted to the blockchain node 102. To track the manufacturer, such as to enable interested parties in ensuring that the manufacturer for the specific handbag is genuine, the manufacturer may provide identification information to the blockchain node 102. For example, the manufacturer may generate a digital signature using its private key that is submitted with the unique identifier and included in the blockchain data value, which would then enable any interested party to verify the digital signature using a public key provided by the manufacturer to ensure that the submission is genuinely from the manufacturer. In some embodiments, the manufacturer may (e.g., via the participant device 106) hash the unique identifier and provide the resulting asset identifier to the blockchain node 102. In other embodiments, the blockchain node 102 may generate the asset identifier by hashing the unique identifier, such as to reduce the complexity for participating entities.

In the above example, a new blockchain data value may be stored in partition A in a new block added to the blockchain following the manufacturer's submission. The distributor may pick up the handbag and make a new submission to a blockchain node 102 that includes the unique identifier and its own digital signature, where a new blockchain data value may be created and stored in partition B that is added to a new block in the blockchain with the asset identifier and the distributor's digital signature. When the handbag arrives at the distributor's storage facility, a new submission may be made to a blockchain node 102 for storage of a new blockchain data value in partition C. For example, a machine-readable code, such as a barcode, may be printed on a tag attached to the handbag that is encoded with the unique identifier, such that an employee of the distributor can scan the machine-readable code at each relevant step in the process that may result in a submission of the unique identifier, the entity's digital signature, and an indicator of the state value to a blockchain node 102 for quick updating of the state value in the blockchain.

Because the blockchain is immutable and each block includes a timestamp, any interested party may be quickly able to identify the current state of an asset through use thereof. For example, a consumer may purchase a new designer handbag from the manufacturer to be custom-made. The manufacturer may produce the new handbag and provide the consumer with the unique identifier. The consumer may then monitor the blockchain to be able to quickly identify, using the asset identifier and through the partition where the asset identifier shows up, where the handbag is in the manufacture and distribution process. For instance, when a new block is added to the blockchain that includes the asset identifier in a blockchain data value in partition E, the consumer would know that the handbag has been delivered to a retailer to be picked up by the consumer. The manufacturer may monitor the blockchain to identify when a new block is added that includes the asset identifier in a blockchain data value in partition F to know that the consumer picked up the handbag.

In some embodiments, submissions to blockchain nodes 102 may include an indication of the state value or desired partition for an asset. For instance, the distributor in the above example may indicate partition C when the handbag arrives at their storage facility. In other embodiments, the partitions may be ordered such that a submission of an asset identifier may be attributed to the next partition in the ordering. For instance, in the above example, if the asset identifier has already been stored in blockchain data values in partitions A, B, and C, a new submission of the asset identifier may result in a new blockchain data value being created in partition D for the next block being generated. In another embodiment, the partition where an asset identifier is to be included may be based on the submitter. For instance, in the above example, if the digital signature is generated by the retailer (e.g., verified by the blockchain node 102 using the public key of the retailer's cryptographic key pair), the new blockchain data value may be included in partition E. In yet another embodiment, the blockchain data values may be used to store data regarding transfer of ownership of the asset from one entity to another, such as through a blockchain transaction as discussed above.

In some embodiments, blockchain nodes 102 may be configured to monitor for event states of assets. For instance, a blockchain node 102 may have an asset registered therewith where the blockchain node 102 may monitor for state updates for that particular asset. In such an instance, the blockchain node 102 may generate new blockchain data values for all assets when new submissions are received, but may track particular, registered assets. In the above example, for instance, the consumer that ordered the custom handbag may register the custom handbag's unique identifier or asset identifier with a particular blockchain node 102 using a participant device 106. The blockchain node 102 may store the asset identifier and monitor for state updates for that asset in the blockchain, such as by reviewing blockchain data entries included in new blocks for the asset identifier. In cases where partitions may be ordered, the blockchain node 102 may only review the expected partition(s) for the registered asset. For instance, in the above example, if the asset identifier had already been stored in partitions A and B, the blockchain node 102 may only review new blockchain data entries in partition C in new blocks until the asset identifier is identified therein. In some cases, a blockchain node 102 may store data entries in storage thereof for registered assets, which may include, for example, the asset identifier, unique identifier, and any state information (e.g., latest partition where the asset identifier was stored in a blockchain data value).

In some embodiments, blockchain nodes 102 may be configured to perform actions following state changes for assets. In some instances, actions may only be performed following state changes for registered assets, and may, in some cases, only perform preauthorized actions. In the above example, the blockchain node 102 may be configured to transmit a notification message to the participant device 106 of the consumer that ordered the custom handbag once the state of the custom handbag (e.g., identified via the asset identifier) has changed to partition E. In another example, if a blockchain is used to store data regarding the manufacture and distribution of controlled pharmaceuticals, a blockchain node 102 may be configured to automatically submit reports when the state for assets has changed to a specific state, such as to comply with auditing and reporting regulations. In some instances, every blockchain node 102 in the blockchain network 104 may be configured to perform one or more predetermined actions upon a specific state change. In other instances, only some blockchain nodes 102 may be configured to perform the actions. In some cases, the actions themselves may be registered with individual blockchain nodes 102, such as through participant devices 106 (e.g., as in the above example with the consumer being notified of the custom handbag delivery). The actions to be performed may be any suitable action that can be performed by a blockchain node 102, such as the creation of new blockchain data values, transmission of data messages to external devices, etc.

In some cases, participant devices 106 or other computing devices may be configured to perform actions as a result of state changes of assets as tracked in the blockchain. For example, a participant device 106 may monitor new blocks added to the blockchain and detect a state change and then perform one or more actions as discussed above. In another example, the blockchain node 102 may monitor for state changes for a registered asset and, when a state change is detected, may perform an action that consists of notifying a specific participant device 106 of the state change (e.g., of the asset whose state changed and the new asset stage), where the participant device 106 may then perform one or more actions as a result of the state change.

In some instances, the blockchain may utilize smart contracts. Smart contracts may be scripts that are stored in the blockchain that may be self-executing upon the satisfaction of one or more criteria. In some cases, the one or more criteria may be the state change of an asset. For example, a smart contract may be added to the blockchain in the first partition that an asset is added to, where the smart contract may be executed any time the asset identifier is added to a new partition (e.g., in a blockchain data value in that partition in a new block that is added to the blockchain), which may result in a different action based on the partition to which the asset identifier has been added. In this manner, smart contracts may be utilized to have actions performed upon state changes for assets in the same manner as discussed above, which may be agnostic to the blockchain nodes 102 themselves, as the smart contracts are stored in the actual blockchain. In some cases, a separate partition may be included in the blockchain for the storage of smart contracts. In some embodiments, partitions may be used to define actions to be performed upon state changes for assets. For instance, a partition may have a defined set of actions to be performed on specific state changes, where any asset identifier stored in that partition may have actions executed in accordance therewith when the state of the associated asset changes, while each of such partitions may have a different defined set of actions. In such an instance, when a new asset is added to the blockchain, it may be added in the appropriate partition for the desired set of actions to be performed. In the above example, the handbag manufacturer may submit custom handbags to a different action partition than non-custom handbags.

The methods and systems discussed herein use partitioned blockchains to store state information for assets. By using a blockchain, the record for the state of assets is immutable and can be immediately audited and verified by any interested party. The use of a partitioned blockchain, where each partition is associated with a different state, can provide for quicker identification of the state of an asset without the need to store specific state information in every single entry, which can drastically reduce the file size of blockchain data values, and thus the blockchain as a whole, and significantly reduce bandwidth for messages and transmission of the blockchain itself. Additionally, the use of predetermined partitions that represent states can reduce the data necessary for submissions to update asset states if there is specific ordering regarding the partitions. Furthermore, blockchain nodes 102 can be configured to perform one or more actions when a state change is detected, where the state change is detected based on the partition that an asset identifier is stored in in a new block, which can provide for customized interactions and behaviors based on asset state changes without the need to submit any information to any entities as the blockchain nodes 102 are already receiving the blockchain data, and can be done with a minimal amount of data review. Accordingly, the methods and systems discussed herein provide for significant technological advantages over traditional blockchains for the storage of asset state information by use of a partitioned blockchain and the methods discussed herein.

### Blockchain Node

FIG. 2 illustrates an embodiment of a blockchain node 102 in the system 100. It will be apparent to persons having skill in the relevant art that the embodiment of the blockchain node 102 illustrated in FIG. 2 is provided as illustration only and may not be exhaustive to all possible configurations of the blockchain node 102 suitable for performing the functions as discussed herein. For example, the computer system 500 illustrated in FIG. 5 and discussed in more detail below may be a suitable configuration of the blockchain node 102.

The blockchain node 102 may include a receiving device 202. The receiving device 202 may be configured to receive data over one or more networks via one or more network protocols. In some instances, the receiving device 202 may be configured to receive data from other blockchain nodes 102, participant devices 106, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by participant devices 106 that may be superimposed or otherwise encoded with registration data, such as public keys, asset identifiers, unique identifiers, asset states, requested actions to be performed for asset states, etc. The receiving device 202 may also be configured to receive data signals electronically transmitted by other blockchain nodes 102, such as may be superimposed or otherwise encoded with blockchain data values, new blocks, confirmation messages, asset identifiers, asset state data, actions associated with asset states and/or assets, or other data used in the operation and management of the blockchain.

The blockchain node 102 may also include a communication module 204. The communication module 204 may be configured to transmit data between modules, engines, databases, memories, and other components of the blockchain node 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the blockchain node 102 and external components of the blockchain node 102, such as externally connected databases, display devices, input devices, etc. The blockchain node 102 may also include a processing device. The processing device may be configured to perform the functions of the blockchain node 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The blockchain node 102 may also include blockchain data 206, which may be stored in a memory 212 of the blockchain node 102 or stored in a separate area within the blockchain node 102 or accessible thereby. The blockchain data 206 may include a blockchain, which may be comprised of a plurality of blocks and be associated with the blockchain network 104. The blockchain data 206 may also or alternatively include any data associated with one or more blockchain wallets that may be used by the blockchain node 102, such as cryptographic key pairs, unspent transaction outputs, digital asset amounts, network identifiers for the blockchain network 104, smart contracts, signature generation algorithms, encryption algorithms, transaction account data, account balances, communication information for third party services, etc. The blockchain data 206 may also include data regarding partitions, such as subnet identifiers, associated asset states, actions to be performed on assets stored in each partition, etc. The blockchain data 206 may also include smart contracts, executable scripts, or other data regarding actions to be performed based on asset states.

The blockchain node 102 may also include asset data values 208. Asset data values 208 may be data values associated with assets registered with the blockchain node 102. An asset data value 208 may include, for instance, a unique identifier and/or asset identifier, and any other information suitable for use in performing the functions discussed herein, such as a status indicator for a current asset state, and one or more actions to be performed for one or more asset states for the related asset. For example, an asset data value 208 may include an executable script or program instruction to be executed for each of a plurality of different asset states for a related asset.

The blockchain node 102 may also include a memory 212. The memory 212 may be configured to store data for use by the blockchain node 102 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the blockchain node 102 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for blockchain nodes 102 and blockchain networks 104, address generation and validation algorithms, digital signature generation and validation algorithms, hashing algorithms for generating reference values, data for the generation and execution of smart contracts, configuration data, etc.

The blockchain node 102 may include a querying module 214. The querying module 214 may be configured to execute queries on databases to identify information. The querying module 214 may receive one or more data values or query strings, and may execute a query string based thereon on an indicated database, such as the memory 212 of the blockchain node 102 to identify information stored therein. The querying module 214 may then output the identified information to an appropriate engine or module of the blockchain node 102 as necessary. The querying module 214 may, for example, execute a query on the asset data values 208 to identify an asset data value 208 that includes an asset identifier included in a blockchain data value in a new partition in a new block for identification of any actions to be performed as a result of the asset state change for the related asset. The querying module 214 may also be execute queries on blockchain data 206 to identify state changes of assets as the result of the asset identifier for the asset being included in a new partition as indicated in a new block received by the blockchain node 102 that has been confirmed for addition to the blockchain.

The blockchain node 102 may also include a generation module 216. The generation module 216 may be configured to generate data for use by the blockchain node 102 in performing the functions discussed herein. The generation module 216 may receive instructions as input, may generate data based on the instructions, and may output the generated data to one or more modules of the blockchain node 102. For example, the generation module 216 may be configured to generate blockchain data values, new blocks, block headers, reference values, smart contracts, etc. The generation module 216 or other processing module of the blockchain node 102 may be further configured to perform actions, such as via the execution of smart contracts or other actions that may be necessary following a detected state change of a registered asset.

The blockchain node 102 may also include a validation module 218. The validation module 218 may be configured to perform validations for the blockchain node 102 as part of the functions discussed herein. The validation module 218 may receive instructions as input, which may also include data to be used in performing a validation, may perform a validation as requested, and may output a result of the validation to another module or engine of the blockchain node 102. The validation module 218 may, for example, be configured to validate digital signatures using suitable signature generation algorithms and keys, validate transaction values, and other data as discussed herein.

The blockchain node 102 may also include a transmitting device 220. The transmitting device 220 may be configured to transmit data over one or more networks via one or more network protocols. In some instances, the transmitting device 220 may be configured to transmit data to other blockchain nodes 102, participating devices 106, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to participant devices 106, such as may be superimposed or otherwise encoded with requests for registration data, notifications regarding asset state changes, current asset states, other data as a result of the performance of one or more actions as a result of an asset state change, etc. The transmitting device 220 may also be configured to electronically transmit data signals to other blockchain nodes 102 that may be superimposed or otherwise encoded with blockchain data values, new blocks, confirmation messages, asset state data, current asset states, asset information, actions to be performed on asset state changes, or other data used in the operation and management of the blockchain

### Process for Representing Asset State in a Partitioned Blockchain

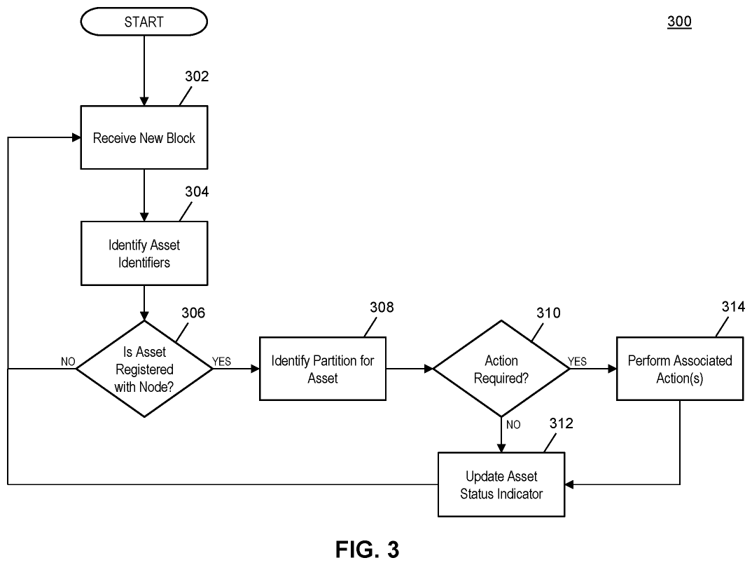

FIG. 3 illustrates a process 300 for the representation of the state of an asset in a blockchain using blockchain partitions in the system 100 illustrated in FIG. 1 and discussed above.

In step 302, the receiving device 202 of a blockchain node 102 in the blockchain network 104 in the system 100 may receive a new block that has been confirmed for addition to the blockchain. The new block may include a block header and one or more blockchain data values for each of a plurality of partitions, where each partition represents an asset state for assets being tracked in the blockchain. In step 304, the querying module 214 of the blockchain node 102 may query the blockchain data values included in the new block to identify assets included therein, such as by identifying the asset identifiers included in each of the blockchain data values.

In step 306, the blockchain node 102 may identify if any of the identified assets are registered with the blockchain node 102. A registered asset may have an asset identifier associated therewith stored in the asset data values 208 stored in the blockchain node 102, where step 306 may involve the blockchain node 102 determining if any of the asset identifiers identified in step 304 are registered in the asset data values 208. If none of the asset identifiers found in the new block is registered with the blockchain node 102, then the process 300 may return to step 302 to await a new confirmed block that is added to the blockchain. In some embodiments, the blockchain node 102 may still proceed to step 308 even if none of the asset identifiers is registered, as the asset may be registered with that blockchain node 102 at a later point in time and the state change information may still be recorded on the blockchain. If one or more of the assets whose state was changed in the new block (e.g., by the associated asset identifier being found in a blockchain data value in the new block) is registered with the blockchain node 102, then, in step 308, the blockchain node 102 may identify the partition in which the registered asset was found in the new block. Identification of the partition may be based on the partition in which the blockchain data value that includes the asset identifier was found, where identification of which may be based on the configuration of the blockchain and blocks for the partitioned blockchain.

In step 310, the blockchain node 102 may determine if any actions must be performed as a result of the state changes for the registered asset(s). The querying module 214 of the blockchain node 102 may execute one or more queries on the asset data values 208 to identify if any actions are to be performed as a result of the change to that state. If no actions are to be performed (e.g., the asset has changed to a state without any predefined actions), then, in step 312, the querying module 214 may execute a query on the asset data value 208 for each registered asset to update the current state of the respective asset by updating a status indicator stored therein based on the partition in which the associated asset identifier was found in the new block. Then, the process may return to step 302 to await receipt of a new block. If any actions are to be performed, then, in step 314, the blockchain node 102 may perform the action(s) as required for each of the registered assets, as applicable. Then, the process 300 may proceed to step 312 to update the status of each of the registered assets for which an action was performed, and then return to step 302 to await receipt of a new block.

### Exemplary Method for Representing Asset State Through Partitioned Blockchains

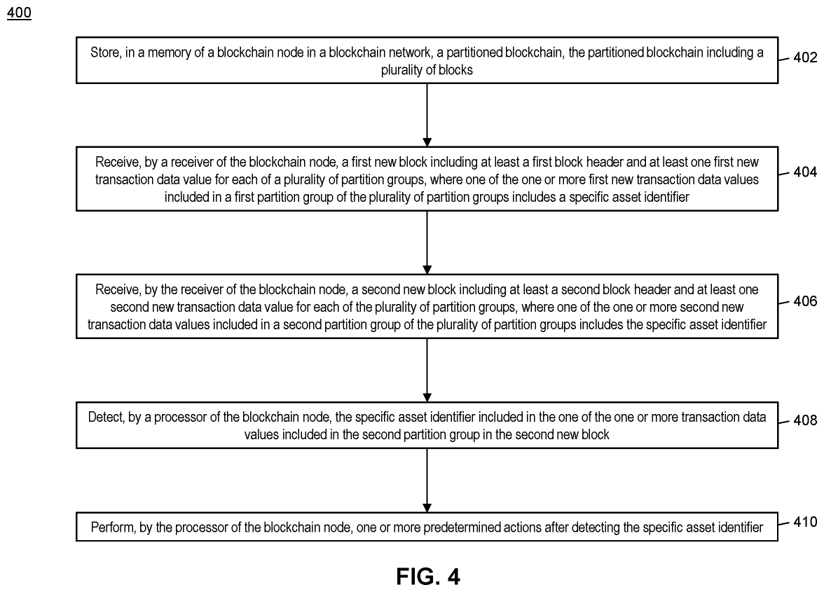

FIG. 4 illustrates a method 400 for representing the state of an asset via the use of partitions in a partitioned blockchain.

In step 402, a partitioned blockchain may be stored in a memory (e.g., memory 212) of a blockchain node (e.g., blockchain node 102) in a blockchain network (e.g., blockchain network 104), the partitioned blockchain including a plurality of blocks. In step 404, a first new block including a first block header and at least one first new transaction data value for each of a plurality of partition groups may be received by a receiver (e.g., receiving device 202) of the blockchain node where one of the one or more first new transaction data values included in a first partition group of the plurality of partition groups includes a specific asset identifier.

In step 406, a second new block including at least a second block header and at least one second new transaction data value for each of the plurality of partition groups may be received by the receiver of the blockchain node, where one of the one or more second new transaction data values included in a second partition group of the plurality of partition groups includes the specific asset identifier. In step 408, the specific asset identifier may be detected by a processor (e.g., querying module 214) of the blockchain node as being included in the one of the one or more transaction data values included in the second partition group in the second new block. In step 410, one or more predetermined actions may be performed by the processor of the blockchain node after detecting the specific asset identifier.

In one embodiment, the one or more predetermined actions may include generating, by the processor (e.g., generation module 216) of the blockchain node, a third new block, the third new block including at least a third block header and at least one third new transaction data value for each of the plurality of partition groups, where one of the one or more third new transaction data values included in a third partition group includes the specific asset identifier. In a further embodiment, the method 400 may further include transmitting, by a transmitter (e.g., transmitting device 220) of the blockchain node, the generated third new block to a plurality of additional nodes in the blockchain network.

In some embodiments, the one or more predetermined actions may include executing, by the processor of the blockchain node, an executable script associated with the specific asset identifier. In a further embodiment, the method 400 may further include storing, in the memory of the blockchain node, a data pair (e.g., asset data value 208) including the specific asset identifier and the executable script. In another further embodiment, the method 400 may also include storing, in the memory of the blockchain node, a data entry including the specific identifier and a plurality of scripts, wherein the executable script is associated with a status indicator associated with the second partition group.

In one embodiment, the method 400 may further include: storing, in the memory of the blockchain node, a data pair including the specific asset identifier and a status indicator associated with the first partition group; and updating, by the processor of the blockchain node, the status indicator in the data pair including the specific asset identifier to a new status indicator associated with the second partition group after detecting the specific asset identifier. In some embodiments, the memory may include an original asset identifier, and the specific asset identifier may be a hash value of the original asset identifier.

### Computer System Architecture

FIG. 5 illustrates a computer system 500 in which embodiments of the present disclosure, or portions thereof, may be implemented as computer-readable code. For example, the blockchain node 102 of FIGS. 1 and 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for representing state of an asset through a partitioned blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for representing state of an asset through a partitioned blockchain, comprising:
storing, in a memory of a blockchain node in a blockchain network, a partitioned blockchain, the partitioned blockchain including a plurality of blocks;
receiving, by a receiver of the blockchain node, a first new block including at least a first block header and at least one first new transaction data value for each of a plurality of partition groups, where one of the one or more first new transaction data values included in a first partition group of the plurality of partition groups includes a specific asset identifier;
receiving, by the receiver of the blockchain node, a second new block including at least a second block header and at least one second new transaction data value for each of the plurality of partition groups, where one of the one or more second new transaction data values included in a second partition group of the plurality of partition groups includes the specific asset identifier;
detecting, by a processor of the blockchain node, the specific asset identifier included in the one of the one or more transaction data values included in the second partition group in the second new block; and
performing, by the processor of the blockchain node, one or more predetermined actions after detecting the specific asset identifier.

2. The method of claim 1, wherein the one or more predetermined actions includes generating, by the processor of the blockchain node, a third new block, the third new block including at least a third block header and at least one third new transaction data value for each of the plurality of partition groups, where one of the one or more third new transaction data values included in a third partition group includes the specific asset identifier.

3. The method of claim 2, further comprising:
transmitting, by a transmitter of the blockchain node, the generated third new block to a plurality of additional nodes in the blockchain network.

4. The method of claim 1, wherein the one or more predetermined actions includes executing, by the processor of the blockchain node, an executable script associated with the specific asset identifier.

5. The method of claim 4, further comprising:
storing, in the memory of the blockchain node, a data pair including the specific asset identifier and the executable script.

6. The method of claim 4, further comprising:
storing, in the memory of the blockchain node, a data entry including the specific identifier and a plurality of scripts, wherein
the executable script is associated with a status indicator associated with the second partition group.

7. The method of claim 1, further comprising:
storing, in the memory of the blockchain node, a data pair including the specific asset identifier and a status indicator associated with the first partition group; and
updating, by the processor of the blockchain node, the status indicator in the data pair including the specific asset identifier to a new status indicator associated with the second partition group after detecting the specific asset identifier.

8. The method of claim 1, wherein
the memory includes an original asset identifier, and
the specific asset identifier is a hash value of the original asset identifier.

9. A system for representing state of an asset through a partitioned blockchain, comprising:
a blockchain network; and
a blockchain node included in the blockchain network, the blockchain node including
a memory storing a partitioned blockchain, the partitioned blockchain including a plurality of blocks,
a receiver receiving
a first new block including at least a first block header and at least one first new transaction data value for each of a plurality of partition groups, where one of the one or more first new transaction data values included in a first partition group of the plurality of partition groups includes a specific asset identifier, and
a second new block including at least a second block header and at least one second new transaction data value for each of the plurality of partition groups, where one of the one or more second new transaction data values included in a second partition group of the plurality of partition groups includes the specific asset identifier, and
a processor
detecting the specific asset identifier included in the one of the one or more transaction data values included in the second partition group in the second new block, and
performing one or more predetermined actions after detecting the specific asset identifier.

10. The system of claim 1, wherein the one or more predetermined actions includes generating, by the processor of the blockchain node, a third new block, the third new block including at least a third block header and at least one third new transaction data value for each of the plurality of partition groups, where one of the one or more third new transaction data values included in a third partition group includes the specific asset identifier.

11. The system of claim 10, wherein the blockchain node further includes a transmitter transmitting the generated third new block to a plurality of additional nodes in the blockchain network.

12. The system of claim 9, wherein the one or more predetermined actions includes executing, by the processor of the blockchain node, an executable script associated with the specific asset identifier.

13. The system of claim 12, wherein the memory of the blockchain node further stores a data pair including the specific asset identifier and the executable script.

14. The system of claim 12, wherein
the memory of the blockchain node further stores a data entry including the specific identifier and a plurality of scripts, and
the executable script is associated with a status indicator associated with the second partition group.

15. The system of claim 9, wherein
the memory of the blockchain node further stores a data pair including the specific asset identifier and a status indicator associated with the first partition group; and
the processor of the blockchain node further updates the status indicator in the data pair including the specific asset identifier to a new status indicator associated with the second partition group after detecting the specific asset identifier.

16. The system of claim 9, wherein
the memory includes an original asset identifier, and
the specific asset identifier is a hash value of the original asset identifier.
